(19) United States
(12) Patent Application Publication
(10) Pub. No.: US 2016/0019707 A1
(43) Pub. Date: Jan. 21, 2016

(54) MIXED MEDIA FILE SYSTEM

(71) Applicant: Roovy, Inc., San Diego, CA (US)

(72) Inventors: Touradj Barman, San Diego, CA (US); Scott Webber, Toledo, OH (US)

(21) Appl. No.: 14/804,320

(22) Filed: Jul. 20, 2015

Related U.S. Application Data
(60) Provisional application No. 62/026,479, filed on Jul. 18, 2014.
(60) Provisional application No. 62/040,791, filed on Aug. 22, 2014.

(51) Int. Cl. G06T 11/60; H04L 29/08; G06F 17/22; H04L 29/06

(52) U.S. Cl. CPC G06T 11/60; H04L 65/602; H04L 67/06; G06F 17/2235

(57) ABSTRACT

Some embodiments include a method for creating and displaying media resources. In some embodiments a method may include receiving a first media item from a first client; storing the first media item in a first storage location; receiving a link to a second media item located at a remote location; storing the link to the second media item in a second storage location; organizing the first media item into a mixed media file system including the first media item; and organizing the second media item into the mixed media file system including the link to the second media item; creating a visual representation of the mixed media file system, wherein the representation of the first media item and the representation of the second media item are not distinguishable based on the difference in the storage location of the first media item and the second media item.

### SUMMARY

Embodiments of the invention include a method for uploading, referencing, organizing, linking, and/or presenting mixed media that includes both media and links to media in a single file system. The disclosed embodiments solve problems that exist in the unique and highly connected digital word of the Internet and/or allow users to collect and/or share media in pods or folders or other groups or collections of mixed media items across various devices.

Some embodiments include a method for creating and displaying media resources. In some embodiments, a method may include receiving a first media item from a first client; storing the first media item in a first storage location; receiving a link to a second media item located at a remote location; storing the link to the second media item in a second storage location; organizing the first media item into a mixed media file system including the first media item; organizing the second media item into the mixed media file system including the link to the second media item; creating a visual representation of the mixed media file system that includes a representation of the first media item and a representation of the second media item, wherein the representation of the first media item and the representation of the second media item are not distinguishable based on the difference in the storage location of the first media item and the second media item; and displaying the visual representation of the mixed media file system on the first client.

These illustrative embodiments are mentioned not to limit or define the disclosure, but to provide examples to aid understanding thereof. Additional embodiments are discussed in the Detailed Description, and further description is provided therein. Advantages offered by one or more of the various embodiments may be further understood by examining this specification or by practicing one or more embodiments presented.

### BRIEF DESCRIPTION OF THE FIGURES

These and other features, aspects, and advantages of the present disclosure are better understood when the following Detailed Description is read with reference to the accompanying drawings.

FIG. 1 illustrates an example mixed media file system represented by a pod or folder according to some embodiments described herein.

FIG. 2 is a block diagram of a system for implementing the file system described herein.

FIG. 3 is a flowchart of an example process of uploading a link to a media item and a media item, according to at least one embodiment described herein.

FIG. 4 is a flowchart of an example process for organizing a first media item and a link to a second media item in a folder or a pod according to at least one embodiment described herein.

FIG. 5 is a flowchart of an example process for organizing a first media item and a link to a second media item in a folder or a pod according to at least one embodiment described herein.

FIG. 6 is a flowchart of an example process for organizing a first media item and a link to a second media item in a folder or a pod with thumbnails according to at least one embodiment described herein.

FIG. 7 shows an illustrative computational system for performing functionality to facilitate implementation of embodiments described herein.

### DETAILED DESCRIPTION

Systems and methods are disclosed to provide a mixed media file system that allows both links and data files to be stored and/or organized in the same file system. Some embodiments may improve the functioning of a computer system by providing a file/link management system that manages both locally stored items as well as network items. These improvements may simplify the management of items, files, external files, and/or links and/or consolidate the management of items, files, external files, and/or links. In addition, embodiments may provide improvements to the field for file management and/or the field of user interfaces with a computer. In addition, the various embodiments of mixed media file systems may solve file system organizational problems that are problems particular to the Internet, network computing, and similar systems.

Systems and methods are disclosed to provide a mixed media file system that allows both media items and media available via links to be stored and/or organized in the same file system.

Systems and methods are disclosed to provide a mixed media file system that stores digital content of all media types, including linked assets like YouTube videos and newsfeeds that can't be stored in traditional file storage systems along with traditional media items.

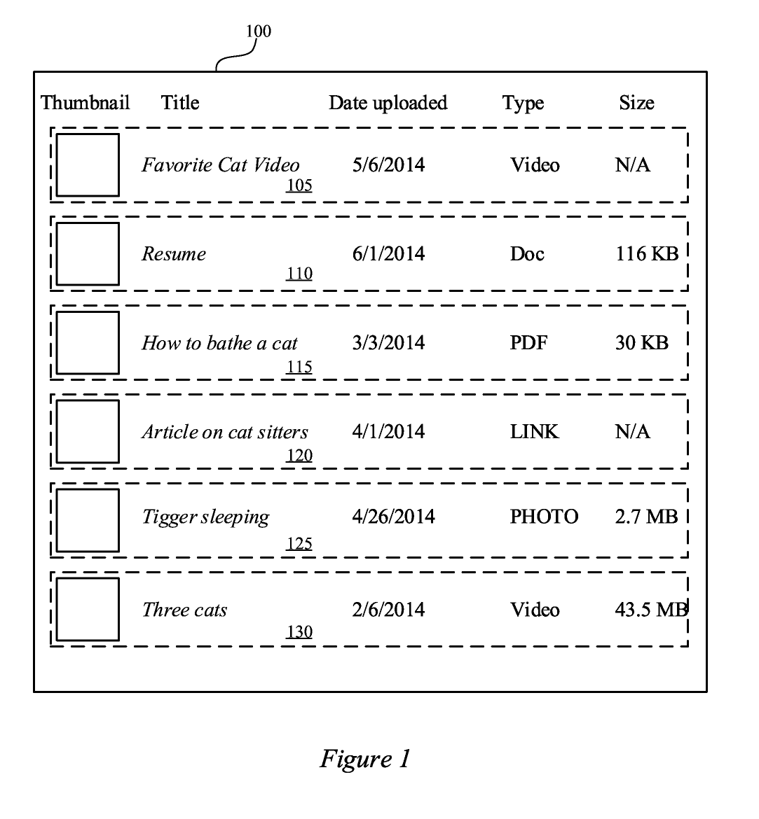

In some embodiments, a mixed media file system may store, organize, and/or present to users both files and/or links to files. In some embodiments, whether the media is available via a file or via a link, the media can be presented in the same manner, or nearly the same manner in the user interface. For example, a link to a YouTube video submitted to a mixed media file system described herein can be viewed in a folder (list, grid, etc.) and played back in a way that looks substantially as if the video was uploaded to the mixed media file system. FIG. 1 illustrates an example mixed media file system represented by a pod or folder according to some embodiments described herein. In this example, six items are organized within a pod 100 (a file system or a folder). In this example, each item in the pod 100 includes an icon, name, date, type and/or size. Various other data may be associated with each item.

In some embodiments, each media item (or node) can be represented by an image that may be provided by a user, an icon representing the item type or source of the item, a thumbnail representing the item or source, a text designation of the item type or source, a title, a description, a comment count, comments, a duration for media like audio and video, the name and date of the person who added it to the mixed media file system, and links to actions, like as in options to open, share, delete it; number of views of the media item, the number of likes of the media item, the number of comments associated with the media item, etc. Various other data about the items may also be presented and/or used to organize the items.

In some embodiments, a user may set the order of the items within the folder/list. The items, for example, may be dragged and dropped in a visual representation of the mixed media file system and the files may then be arranged accordingly.

The first item 105 presented within the pod 100 is a link to a YouTube video with a title “Favorite Cat Video”. The title may be a user defined value that is different than the file name. The link may include a link such as, for example, a URL where the YouTube video may be streamed, viewed and/or downloaded. The link does not include access to the actual video file. The first item 105 may include an icon such as a thumbnail image that may include an image representing the YouTube video and/or may be provided by YouTube (or a third party provider). The name may include a name provided by the user entering the link into the pod 100 and/or the name of the YouTube video hosted by YouTube. The name, for example, may be provided in metadata by YouTube. The size of the first item 105 may also be listed and may include the size of the data the link is pointing to. If a user selects the first item 105, for example, the user may be directed to YouTube to view the video or the YouTube video may be streamed to the user through the client. In some embodiments, the YouTube video may be streamed in a manner that is indistinguishable from a video stored locally at the client or at the server (or file system 205).

The second item 110 presented within the pod 100 is a Microsoft Word document titled “Resume”. The title may be a user defined value that is different than the file name. The word document may be a Microsoft Word document uploaded by a user and stored in the mixed media file system associated with pod 100. The second item 110 may include an icon such as a thumbnail image representing the Microsoft Word document. The name may include the name of the Microsoft Word document uploaded by the user. If a user selects the second item 110, the word document may be downloaded and/or opened.

The third item 115 presented within the pod 100 is a link to a PDF document titled “How to bathe a cat”. The title may be a user defined value that is different than the file name. The link may include a link such as, for example, a URL where the PDF document is stored, where it may be viewed and/or where it may be downloaded. The link does not include the actual PDF document. The third item 115 may include an icon that may include a thumbnail image representing the PDF document. The name may include a name provided by the user entering the link into the pod 100 and/or the name of the PDF document hosted by the third party provider. The size of the third item 115 may also be listed and may include the size of the data the link is pointing to. If a user selects the third item 115, the PDF file from the third party location may be presented to the user via the client for viewing in a manner that is indistinguishable from how a PDF file would be viewed if not hosted at the third party location.

The fourth item 120 presented within the pod 100 is a link to an article on cat sitters hosted on a blog, online newspaper, a social network location, etc. The title may be a user defined value that is different than the article name. The link may include a link such as, for example, a URL where the article is stored, where it may be viewed and/or where it may be downloaded. The link, for example, may not include the actual text or images of the article. The fourth item 120 may include an icon that may include a thumbnail image representing the article. The name may include a name provided by the user entering the link into the pod 100 and/or the name of the article provided by the third party hosting the article. The size of the fourth item 120 may also be listed and may include the size of the data the link is pointing to. If a user selects fourth item 120, the article from the third party location may be sent to the user's client device and displayed to the user in a manner that is indistinguishable from how it would be viewed if it was not hosted at the third party location. In some embodiments, the content (or media item) from the third-party location may be presented/viewable as if the content/file had been provided directly to the mixed media file system rather than just the link.

The fifth item 125 presented within the pod 100 is a link to an image titled “Tigger Sleeping”. The title may be a user defined value that is different than the file name. The link may include a link such as, for example, a URL where the image is stored, where it may be viewed and/or where it may be downloaded. The link does not include the actual image.

In some embodiments, if a link to an image (or any media type) may be provided to the mixed media file system, the image may be set to node type image (or any other type corresponding to the type of media). The node content type and the source may be semi-separate. For example, a node content type might be ‘video,’ but the source may be a link to a YouTube video, or the node content type might be ‘image’ and the source may be a file. In some embodiments, the client can send data to the server in at least three different ways. First, for example, the client may send a link from where the file may be downloaded by the server and stored in the mixed media file system (e.g., when importing a file from Dropbox, Google Drive, iCloud, Picasa, etc.). Second, the client may send a link that will serve as a permanent reference for playback or viewing (e.g., when adding a YouTube link) The server (e.g., file system 205) or client (e.g., mobile device 215 or computer 220) may determine whether to download the item or use the link. Third, the client may send a copy of the media item to the server and the server may save the copy of the media item in the mixed media file system (or server or in a storage location). The fifth item 125 may include an icon that may include a thumbnail of the image. The name may include a name provided by the user entering the link into the pod 100 and/or the name of the image provided by the third party hosting the image or other metadata source, such as the file itself, or a service providing ID3 information for audio files, etc. This may be true for all media types. The size of the fifth item 125 may also be listed and may include the size of the image. If a user selects fifth item 125, the user may be presented to the user via the client for viewing in a manner that is indistinguishable from how a file would be viewed if not hosted at the third party location.

In some embodiments, when a user clicks on an image (e.g., in an image view with metadata, comments, etc.) if the image is hosted at the third party location, the image will be displayed as if the image was hosted locally. In some embodiments, a view to a media item may include redirecting users to third-party destinations or allowing downloads of the media, etc.

The sixth item 130 presented within the pod 100 is a video titled “Three cats”. The title may be a user defined value that is different than the file name. The video may be a video uploaded by a user and stored in the mixed media file system associated with pod 100. The sixth item 130 may include an icon that may include a thumbnail of the video. The name may include the name of the video uploaded by the user. If a user selects the sixth item 130, the video may be downloaded and/or opened.

While six example media items are shown in FIG. 1 and discussed above, any number of items may be stored within the pod 100 without limitation. Moreover, any file type may be uploaded and/or linked to. These file types may include, for example, audio files, PowerPoint documents, Excel Documents, videos, blog entries, social network posts, feeds, podcasts, or web pages, etc., etc. The files may be uploaded by a user and/or a link to the file at a third party site may be provided. When a link and/or a file is selected the media may be downloaded, presented, displayed, streamed, etc. to a user. In some embodiments, links can also point to entire webpages, web sites, news feeds, other pods, events, calendar items, messages, tweets, a poll, an assignment, a widget, nodes or other items in other pods, etc. In some embodiments,

Some embodiments enable media that is provided (or uploaded) to be stored and presented alongside media that is available only via links. Some embodiments know what type of media exists at a URL, e.g., a video at a YouTube URL, and thus can present the primary content of that URL, the video, in a view that displays the content to a user. This may be the same video view that may be used to present a video that was uploaded to the mixed media file system. Media of a similar type may be treated similarly and with the context appropriate for its media type regardless of its source.

Some embodiments may include a tree structure that comprises one or more nodes. A node can be a “pod,” which is the root level container. Within a pod, nodes of any type can be added. Some node types include, but are not limited to: folder, video, image, audio, document, file, feed, and link. For a node with a type specified, a source can also be specified. A source could be a file provided at node creation or it could be a link to a file or stream or other source provided at node creation time. Other fields and attributes can also be specified for nodes.

The following are examples of some fields that can be set for a node:

JSON fields to set:

{

title
summary
artist
is_enabled (bool)
type (one of):

AUDIO
FEED
FILE
HTML
FOLDER
LINK
PDF
PHOTO
POD
POD_REFERENCE
VIDEO

}

For example:

{

“title”: “Title”,
“summary”: “Description”,
“artist”: “Artist”,
“type”: “
audio|feed|file|html|folder|link|pdf|photo|pod|pod_reference|video”,
“content_url”: “http://some.url.com/path”

}

In this example, the “content_url” may include any link where the content can be displayed or played, such as, for example, a YouTube URL or web link to any content that is not being transferred to the server (e.g., file system 205). The “conten_url” may include a link to a third party server, a network location, a local storage location, etc.

As another example:

{

“title”: “Title”,
“summary”: “Description”,
“artist”: “Artist”,
“type”: “
audio|feed|file|html|folder|link|pdf|photo|pod|pod_reference|video “.
“content_src_url”: “http://some.url.com/path/to/file”,

}

In this example, the “content_src_url” may include any link from where a media item can be transferred to the server (or file system 205). The “content_src_url” may link to a web address, a private URL, a temporary URL (e.g., as provided by Dropbox, Google Drive, or iCloud where a file may be retrieved), or a web link. The “content_src_url” may include a link to a third party server, a network location, a local storage location, etc. The media item may be downloaded from the “content_src_url”.

As another example:

{

“title”: “Title”,
“summary”: “Description”,
“artist”: “Artist”,
“type”:
“audio|feed|file|html|folder|link|pdf|photo|pod|pod_reference|video”,
“content_src_url”: “cid:attachment_name”,

}

In this example, a media item may be uploaded by the user to the server (or file system 205) from the client (e.g., mobile device 215 or computer 220).

The following are similar examples for uploading a thumbnail image:

{

“image_url”: “http://some.url.com/path/to/image”,
or
“image_src_url”: “http://some.url.com/path/to/image/file”,
or
“image_src_url”: “cid:image_attachment_name”,

}

To add a link to a media item to a pod, a new node may be created within the pod with the type set to the node content type such as, for example, audio, image, video, etc., and the source set to the URL or link where the content is located. In some embodiments, the type may be set based on the URL. For example, for a URL for a YouTube video, the type may be automatically set because it is recognized that YouTube only hosts videos.

In some embodiments, a node may also have fields for Title, Description, authorship, and thumbnail, among others (see below). In some embodiments, when a link is submitted during the creation of a node, metadata for other fields may be retrieved from the media item host. For example, if a YouTube video URL is received, the system may connect to YouTube via a YouTube API and request the video's title, description, duration, view count, ‘likes’ and ‘dislikes’ count, author, thumbnail and/or other data. These items may be added to the node data.

This same process can take place for other types of media and/or using other third-party services. For example, a URL link to a Vimeo video could be provided and would be turned into a node similarly as described for the YouTube example. Or a URL link for a SoundCloud song could be provided and could be turned into a node for audio similarly as described for the YouTube URL.

In some embodiments, a pod may include any number of fields. These fields may include, for example, any or all of the fields described in the following paragraphs.

A parent field, for example, may include a pointer to a parent node or pod.

A pod field, for example, may include a pointer to a pod containing the node. For some nodes this pointer may point back to the node itself signifying that the node is a pod.

A sort index field, for example, may include data that orders the node among its sibling nodes. This field, for example, may include a number that may provide the relative ordered location of the node among its sibling nodes. For example, if there are fifteen sibling nodes, then the sort index field may include a number between one and fifteen. This field may be updated as media items are added to the pod or as media items are reorganized within the pod.

A node content type field, for example, may include data specifying the node type. For example, the node content type field may include data that indicates the type of node such as, for example, AUDIO, PHOTO, VIDEO, POD, FEED, LINK, FILE, HTML, etc. Additional node content types are described below. As another example, the node content type field may include a unique identifier or enumerated constants such as, for example, a string, constant, or list that represents the type of the media item.

A user field, for example, may include the user ID, name, email address, or username of the node creator. Additionally or alternatively, the user field may include a link to the user data item in a database that includes information about the user such as, for example, the user ID, email address, name, etc. of the user.

A last modified user field, for example, may include the name or user name of a user who last changed the node.

A create date field, for example, may include the time the node was created.

A last modified date field, for example, may include the time of the last time the node was modified.

A filename field, for example, may include an internal storage location (e.g., data storage 206). of file data stored on an internal file system.

An image filename field, for example, may include an internal storage location (e.g., data storage 206) of a thumbnail image representing the node.

A storage type field, for example, may include data specifying whether the node represents local data (e.g., “content_src_url” or data stored in data storage 206) or remote data (e.g., “content_url” or data stored in a remote location such as, for example, third party site 232, streaming media 230, or YouTube 235). For example, the storage type field may include a binary value such as an integer indicating that the node represents local data or indicating that the node represents remote data or vice versa.

An image storage type field, for example, may specify the data type of the thumbnail.

A content md5 field, for example, may include a unique cryptographic hash of content used for caching and verification of the content.

A media md5 field, for example, may include a unique cryptographic hash of the thumbnail used for caching and verification of the media.

An original_filename field, for example, may include the filename of the content when the content is uploaded. The original_filename field may include the name of the file as uploaded or downloaded. For example, the file name may be “Balboa_Park_map.pdf.”

A file size field, for example, may include data specifying the data size of the content.

A length field, for example, may include the length in time of audio or video content.

A width/height field, for example, may include data specifying the dimensions of a photo, image, video, etc. For example, the data may include a value for the width and a value for the height.

A title field, for example, may include the name of the media item. A title field, for example, may be the file name or a different name that may be changed by the user or obtained by a third party. For example, if the original_filename field may be “Balboa_Park_map.pdf,” the title may be changed to “Balboa Park Map,” for example, by a user.

A summary field, for example, may include a metadata description of the media item. In the Balboa Park map example, the summary field may include any text useful to the user to describe the media item or for any other purpose, such as, “A handy map of Balboa Park.”

A keywords field, for example, may include one or more keywords and/or terms that may be used for search and/or indexing.

A category field, for example, can include data specifying the category of the pod or node. These categories may include, for example, Art, Fashion, News, Sports, Automotive, Travel, Gardening, etc.

A category shuffle order field, for example, may include data used to randomly sort featured/explored pods.

An is_enabled field, for example, may specify whether the node is hidden or visible.

An is_downloadable field, for example, may specify whether the content can be downloaded.

Some embodiments can extract metadata from a file, such as title, author, album and duration from an audio file and add that to the node data. In some embodiments, a third-party service can be used to request metadata for a file or link or similar item.

In some embodiments, a media item such as, for example, a video can be added to a pod as a node. The media item can be added from a client such as, for example, an app, an application, a website, etc. The media item may be selected from within a client device's storage location and uploaded or it can be recorded and uploaded. The media item may also be selected from a third-party service such as Dropbox or Google Drive. In some embodiments, a new node can be created with the “type” set as “video”. The actual video file may then be uploaded and stored on a server hosted, maintained and/or used by the system.

In some embodiments, the mixed media file system may automatically assign a file to a set type. For example, the mixed media file system may determine that a file is an image or video if it is being saved by a camera app or camera API. A file being saved by a photo viewing app may also be assigned the type photo or video. In some embodiments, the file extension of the file may be used to identify the type. In some embodiments, metadata or MIME data related to the file may be used to determine the file type, which can be used to determine or influence the node type.

In some embodiments, if the media item was recently recorded or was selected from a client device storage, the client may upload the media item to the mixed media file system. If the media item is selected from a third-party service, the server (e.g., the file system 205) may fetch the file from the third-party service and may store it (e.g., at data storage 206). In some embodiments, the client may download it to the device and upload it to the server (e.g., file system 205), or the server may use a link to the media item pointing to a location at the third-party service, and the server may upload the media item from the third-party service.

In some embodiments, the media item may not be downloadable. Rather, for example, the media item may only be available to be streamed to a client device or embedded in a document. As another example, the media item may be a video hosted by YouTube and a link to the media item may be uploaded to the mixed media file system during node creation. The Media Item Type may be set as “video” and the Node Content Type may be set to “LINK”. In some embodiments, the link to the YouTube video may be uploaded and the user might add it as type “LINK”, but the server (e.g., file system 205) may recognize that the link is to a YouTube video (based on the URL or querying the YouTube API), and establish the type as “video” instead of “LINK”.

Other examples of file types being dependent on the URL may include: Vimeo (video), SoundCloud (audio), Flickr (image), Picasa (image), Instagram (image or short-form video), Facebook (image, video, event, person, etc.), etc. Additionally or alternatively, a media type that may depend on the URL may include files stored on cloud storage services such as, for example, iCloud, Dropbox, etc. In some embodiments, the mixed media file system can integrate with the API of services saving media and ask it what type of media item exists at a link.

In some embodiments, only the media item is extracted from the link. So rather than just keep the link to a YouTube video as a webpage link, the mixed media file system refers to the video (not the webpage including the video).

In some embodiments, when a node is created the user may be queried for other fields of the node such as, for example, “title”, “description”, and/or “thumbnail”, among others. These are commonly referred to as metadata. When a node is added, the user can add these metadata in full or part, or they can add, edit or delete these metadata, in full or in part, at any other time. As described elsewhere, the system has mechanisms to determine some metadata automatically.

In some embodiments, when a user adds a node, edits a node, views a node, comments on a node, ‘likes’ a node, rates a node, copies a node, etc. or otherwise interacts with a node, metadata associated with that action is created and added to the system. For example, the mixed media file system may track the identity of and time when a user adds or edits a node and stores that as additional metadata associated with the node. This metadata may be presented to users in whole or part and/or in derivative and/or used for further processing by the system.

In some embodiments, the mixed media file system may extract some of these metadata from the file itself. For example, if the media item is a video, the mixed media file system may extract a frame of the video and set it to the thumbnail. If the media item is audio, the mixed media file system can read metadata stored in the audio file and extract the audio title, duration, or artist, among other data. “Duration” and “artist” are other examples of fields that can be stored with a node.

In some embodiments, the mixed media file system may also connect to third-party services, e.g., to YouTube via an API, to obtain metadata for media item. This third-party may be the host or source of the media item, or it could be an independent service that provides metadata for files, links and other media.

When a user selects a media item from a list of media items or from some other presentation of media items of a pod, for example, the media items of a folder, a uniform view, such as a list as shown in FIG. 1. In a list view, for example, each media item can be represented by a thumbnail, a title, a description, a duration, a size, a date, a content type, and/or a comment count, etc. Media items in the list may varyingly have none, some, or all of these items.

Each media item may be a node with the “content type” field entered. In this way, the system knows what type of media item it is. For example, two of the items shown in the pod 100 of FIG. 1 are videos. The source of the first item 105 is a link to a YouTube video and the source of the sixth item 130 is a video file that was uploaded to the mixed media file system when it was added to the pod 100 and/or when the node was created. Despite the fact that one video has been provided as a file and one has been provided only as a URL (to a YouTube video), the mixed media file system presents the two videos in line with each other as if they are both videos that can be interacted with similarly. The mixed media file system may be generally agnostic as to the source or the storage location of the files. Because the mixed media file system may know what type of media each of these items is, the mixed media file system can present them similarly.

The mixed media file system may know which nodes are parents, siblings, ancestors, descendants, and children of each other, and/or may maintain the sort order of the various nodes within a pod, folder or node. These can be rearranged at any time by a user. For example, every child of a node may have a sort order value. When a node is requested by a client, the server may return, among other things, information (e.g., a sort order index) specifying the sort order of the children of the node. For example, the server may provide the node ID of all the children and the sort order value. Additionally or alternatively, the server may return the children in the sort order. The sort order ID can indicate to the client the order the children should be organized when displaying the node.

In some embodiments, the title may be different than the file name. A title, for example, may be the file name until or unless a user elects to change it do a different string or value.

The mixed media file system may allow users to make nodes discoverable by other users on the system (e.g., public nodes), even if those nodes have not been directly shared with those users. Other users can search for discoverable nodes based on keyword searching of metadata associated with the node or they can search by category, attribute (e.g., popular, new, etc.), etc. Nodes may also be made private or viewable by invitation.

In some embodiments, a node may be tagged and presented as being of among or within categories and/or sub categories. For example, a node about cooking seafood could be associated with a category Cuisine and sub-category Cooking.

In some embodiments, pods may be designated as private, meaning that their media items can't be viewed unless someone with the capacity to do so shares.

In some embodiments, private communities may be established that contain users and pods that may only be available to users in that community. For example if a private community is established for an organization (e.g., a school, workplace, church, user group, club, team, group, etc.), users not in that community cannot see users or pods in that community.

In some embodiments, nodes may be designated as allowing non-authors to add media items to them. This could allow any type of media item to be posted or only media items that meet certain specifications, e.g., file type, size, category, keywords, or other.

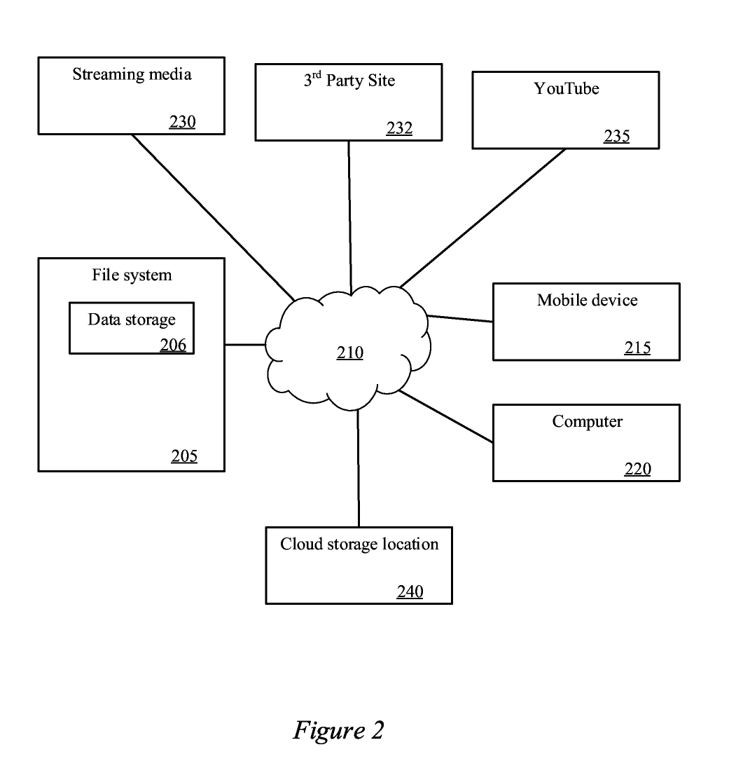

FIG. 2 is a block diagram of a system 200 for implementing the mixed media file system described herein. The file system 205 may include one or more servers or networked computers coupled with the Internet 210. The file system 205 may include a data storage 206 that may be used to store various media items, links, media items, and/or content. The data storage 206 may be used, for example, as a cloud storage location. The file system 205 may also include a web server and/or an app server. Various other servers, services, components, systems, etc. may be included with the file system 205.

In some embodiments, the file system 205 may be in communication with a mobile device 215 and/or a computer 220 through the Internet 210. The user may interact with the file system 205 and/or the various media items and/or content stored within data storage 206 through the mobile device 215 and/or the computer 220. In some embodiments, the user may access the media items and/or content from an app executing on the mobile device 215 and/or through an application executing on the computer 220 and/or through a web page accessible through a web browser on the mobile device 215 and/or the computer 220.

The file system 205 may access files stored at various cloud storage locations 204 such as, for example, Dropbox, Google Drive, OneDrive, Box, Amazon Cloud Drive, iCloud, iDrive, Mozy, Copy, etc.

The file system 205 may also access streaming media stored at YouTube 235 and/or streaming file system 230. The file system 205 may also access media stored at any third party site 232 such as, for example, a webpage, a blog, a cloud server, a cloud storage location, a computer system, etc.

In some embodiments, the data storage 206 may include an external and/or cloud data storage 230 that is separate from the file system 205 but managed by the file system 205. For example, the file system 205 may execute on one or more servers while the data storage 206 may execute on one or more additional servers.

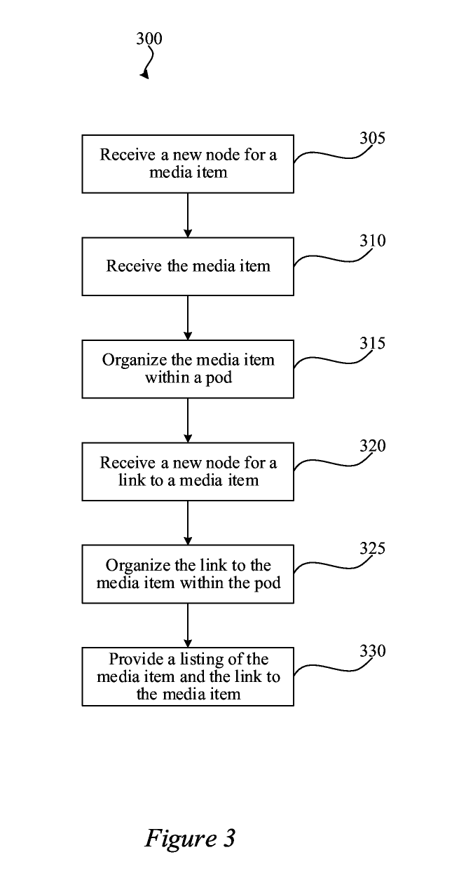

FIG. 3 is a flowchart of an example process 300 of uploading a link to a media item and a media item, according to at least one embodiment described herein. One or more steps of the process 300 may be implemented, in some embodiments, by file system 205, computer 220 and/or mobile device 215. Although illustrated as discrete blocks, various blocks may be divided into additional blocks, reordered, combined into fewer blocks, or eliminated, depending on the desired implementation.

The process 300 may start at block 305 where a request for a new node may be received. The new node may include a first media item that may be uploaded to the file system 205 or a request to have the first media item downloaded from a remote storage location. The request of the new node may be received at the file system 205 from the user through the mobile device 215 and/or the computer 220 through the Internet 210. The request may indicate various fields related to the first media item such as, for example, the name or title of the first media item, a description of the first media item, an artist's name, a summary of the first media item, a media type, a thumbnail representing the first media item, a parent pod or node identifier, etc. Any other information may also be received.

At block 310 the first media item may be uploaded to the file system 205 and/or stored within the data storage 206. The first media item may be uploaded from the mobile device 215, the computer 220, the cloud storage location 240, and/or any other network location. Regardless of the location of the first media item, the first media item may be stored within the data storage 206.

At block 315 the media item may then be organized within a pod or a folder.

At block 320 another request of a new node may be received. The new node may be a link to a second media item located at a network location and that is not uploadable (e.g., a stream) to the file system 205. The request of the new node may be received at the file system 205 from the user through the mobile device 215 and/or the computer 220 through the Internet 210. The request may indicate various fields related to the second media item such as, for example, the name or title of the second media item, a description of the second media item, an artist's name, a summary of the second media item, a thumbnail representative of the second media item, a parent pod or node identifier, etc. The type field of the request may indicate a link. Any other information may also be received. In some embodiments, the link may be a link to a YouTube video that can be streamed from YouTube.com. The link to the second media item may include a link that points to the second media item at a third party and/or remote server. The link to the second media item may include a link that points to a second media item that may be streamed to the computer 220 and/or the mobile device 215 through the Internet 210.

At block 325 the link to the second media item may then be organized within the pod or the folder where the second media item is organized. In this way, both the first media item and/or the link to the second media item may be organized within the pod and/or the folder in the same or substantially the same way.

At block 330 a listing of items within the pod or the folder may be made and/or provided to the user through the Internet 210 such as, for example, as shown in FIG. 1. The listing may include, for example, a thumbnail of the first media item and a thumbnail of the second media item. The listing may include, for example, the name of the first media item and the name of the second media item. The listing may include, for example, any metadata associated with the first media item and any metadata associated with the second media item. Regardless of the way the data is organized within the pod or the folder, the first media item and the second media item are organized in the same manner so that from the user's perspective there is no difference between the presentation of the first media item and the presentation of the second media item except the specific name, title, thumbnail, and/or metadata associated with the first media item and/or the second media item.

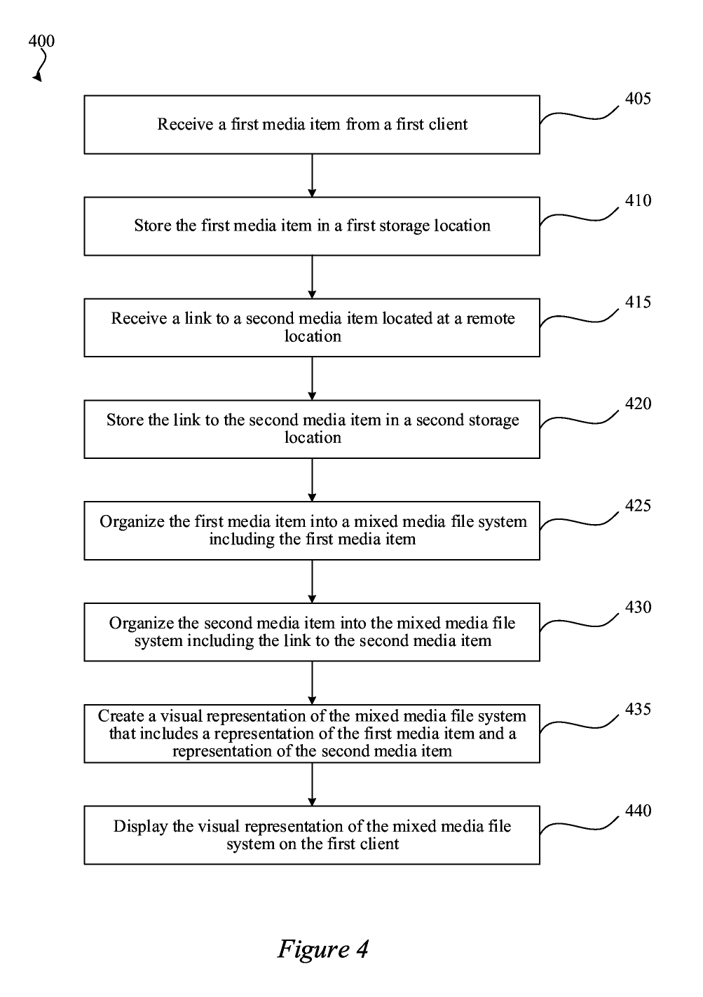

FIG. 4 is a flowchart of an example process 400 for organizing a first media item and a link to a second media item in a folder or a pod according to at least one embodiment described herein. One or more steps of the process 400 may be implemented, for example, by file system 205, computer 220 and/or mobile device 215. Although illustrated as discrete blocks, various blocks may be divided into additional blocks, reordered, combined into fewer blocks, or eliminated, depending on the desired implementation.

The process 400 may start at block 405, where a first media item may be received at the file system 205 from a first client (e.g., mobile device 215 or computer 220). For example, a first media item may be uploaded by a user interfacing with an application or app executing on the first client or via webpage displayed on a web browser executing on the first client. The first client (or the application executing on the first client) or a third party service (e.g., using an API associated with the mixed media file system), for example, may retrieve the first media item from a storage location on the first client and transfer it to the file system 205 via the Internet 210.

At block 410 the first media item may be stored in a first storage location. For example, once the first media item has been received from the first client the first media item may be stored in data storage 206 or cloud storage location 240 or any other storage location.

At block 415 a link to a second media item located at a remote location may be received. The link to the second media item may be received from the first client or another client. The link to the second media item may point to the second media item stored at a remote location such as, for example, at streaming media 230, YouTube 235, or any other location.

At block 420 the link to the second media item may be stored in a second storage location. For example, once the second media item has been received, the second media item may be stored in data storage 206 or cloud storage location 240 or any other storage location.

At block 425 the first media item may be organized into a mixed media file system that includes the first media item. For example, the first media item may be organized into a node and/or a pod as described within this disclosure. As another example, the first media item may be organized in a folder with one or more other media items.

At block 430 the second media item may be organized into a mixed media file system that includes the link to the second media item but not the second media item or a copy of the second media item. For example, the second media item may be organized into a node and/or a pod as described within this disclosure. As another example, the second media item may be organized in a folder with one or more other media items. The first media item and the second media item, for example, may be organized in the same pod or folder without regard to the difference in the storage location of the first media item and the second media item. The first media item and the second media item, as another example, may be organized in the same pod or folder without regard to the difference in that the first media item is stored at the file system 205 and only a link of the second media item is stored at the file system 205.

At block 435 a visual representation of the mixed media file system may be created that includes a representation of the first media item and a representation of the second media item. In some embodiments, the representation of the first media item may be a thumbnail or icon of the first media item and the representation of the second media item may be a thumbnail or icon of the second item. In some embodiments, the representation of the first media item and the representation of the second media item are not distinguishable based on the difference in the storage location of the first media item and the second media item.

At block 440 the visual representation of the pod or folder may be displayed on the first client. For example, a display may be created and sent to the first client. As another example, an HTML or other markup language file may be sent to the first client and may be displayed by the first client. As another example, data (e.g., thumbnail, title, duration, summary, username, source, or number of likes, number of views, etc.) may be sent to the first client and the first client may render the data into a display and may be displayed by the first client.

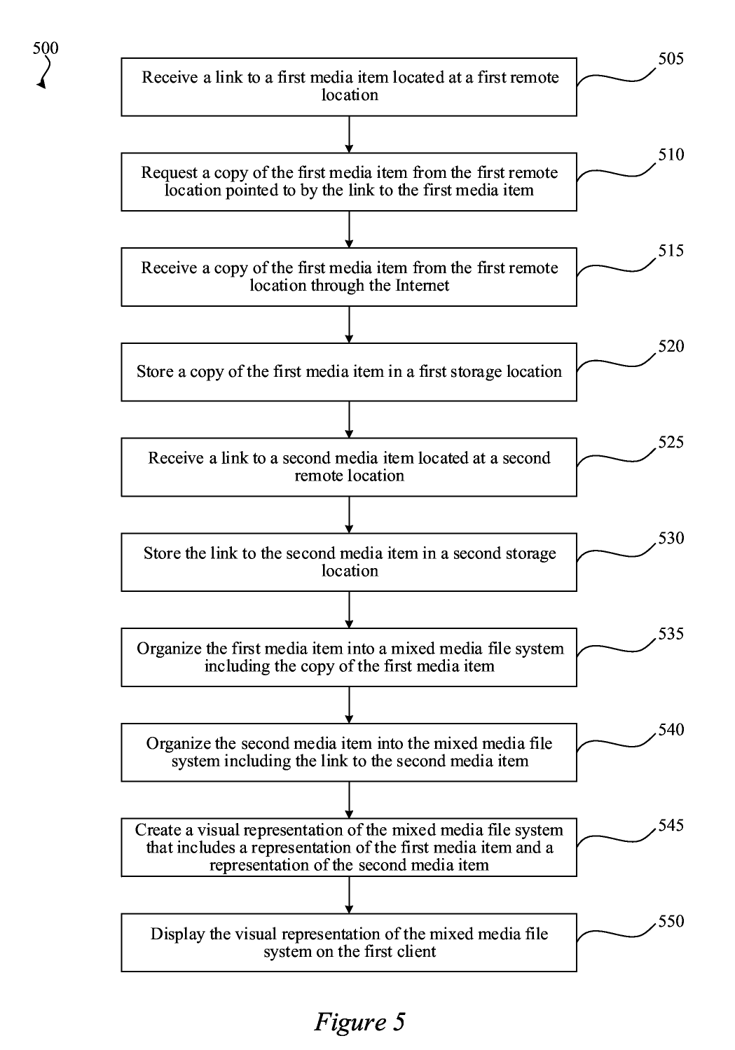

FIG. 5 is a flowchart of an example process 500 for organizing a first media item and a link to a second media item in a folder or a pod according to at least one embodiment described herein. One or more steps of the process 500 may be implemented, in some embodiments, by file system 205, computer 220 and/or mobile device 215. Although illustrated as discrete blocks, various blocks may be divided into additional blocks, reordered, combined into fewer blocks, or eliminated, depending on the desired implementation.

The process 500 may start at block 505 where a link to a first media item located at a first remote location may be received at a server (e.g., the file system 205). The link to the first media item may be received from a client (e.g., a mobile device 215 or a computer 220). The link to the first media item may point to the first media item stored at any remote location such as, for example, a webpage server, another mixed media file system, streaming media 230, YouTube 235, Dropbox, or any other location.

At block 510 a copy of the first media item may be requested from the first media location. The request for the first media item may depend on the type of first remote location. For example, if the first remote location is a webpage server, then the request may include an HTTP GET or an FTP GET command. As another example, the request may include a command as part of the API for the first remote location.

At block 515 a copy of the first media item may be received at the server (e.g., the file system 205) from the first remote location through the Internet. At block 520 the first media item may be stored in a first storage location. For example, once the first media item has been received from the first client the first media item may be stored in data storage 206 or cloud storage location 240 or any other storage location.

At block 525 a link to a second media item located at a remote location may be received. The link to the second media item may be received from the first client or another client. The link to the second media item may point to the second media item stored at a remote location such as, for example, at streaming media 230, YouTube 235, or any other location.

At block 530 the link to the second media item may be stored in a second storage location. For example, once the second media item has been received the second media item may be stored in data storage 206 or cloud storage location 240 or any other storage location.

At block 535 the first media item may be organized into a mixed media file system that includes the first media item. For example, the first media item may be organized into a node and/or a pod as described within this disclosure. As another example, the first media item may be organized in a folder with one or more other media items.

At block 540 the second media item may be organized into a mixed media file system that includes the link to the second media item but not the second media item or a copy of the second media item. For example, the second media item may be organized into a node and/or a pod as described within this disclosure. As another example, the second media item may be organized in a folder with one or more other media items. The first media item and the second media item, for example, may be organized in the same pod or folder without regard to the difference in the storage location of the first media item and the second media item. The first media item and the second media item, as another example, may be organized in the same pod or folder without regard to the difference in that the first media item is stored at the file system 205 and only a link of the second media item is stored at the file system 205.

At block 545 a visual representation of the mixed media file system may be created that includes a representation of the first media item and a representation of the second media item. In some embodiments, the representation of the first media item may be a thumbnail or icon of the first media item and the representation of the second media item may be a thumbnail or icon of the second item. In some embodiments, the representation of the first media item and the representation of the second media item are not distinguishable based on the difference in the storage location or source of the first media item and the second media item.

At block 550 the visual representation of the mixed media file system may be displayed on the first client. For example, a display may be created and sent to the first client. As another example, a display may include any data that may be interpreted or rendered by a client device and presented to a user of the client device via a display. In some embodiments, the display may include an HTML or other markup language file may be sent to the first client and may be displayed by the first client.

In some embodiments, the first thumbnail of the first media item may be created from the first media item. For example, the first thumbnail may be created by saving a lower resolution version of the first media item. As another example, the first thumbnail may be created using a third party network resource that returns a thumbnail of a media item in response to receiving the media item. As another example, the first thumbnail may be created from a frame or page of the first media item.

In some embodiments, the second thumbnail of the second media item may be created from the link to the second media item. As another example, the second thumbnail may be created using a third party network resource that returns a thumbnail of a media item in response to receiving the media item. As another example, the second thumbnail may be created from a frame or page of the second media item. As another example, the second thumbnail may be received from the remote location where the second thumbnail is stored. For instance, some streaming services (e.g., YouTube) may provide a thumbnail in response to a request through the streaming service's API.

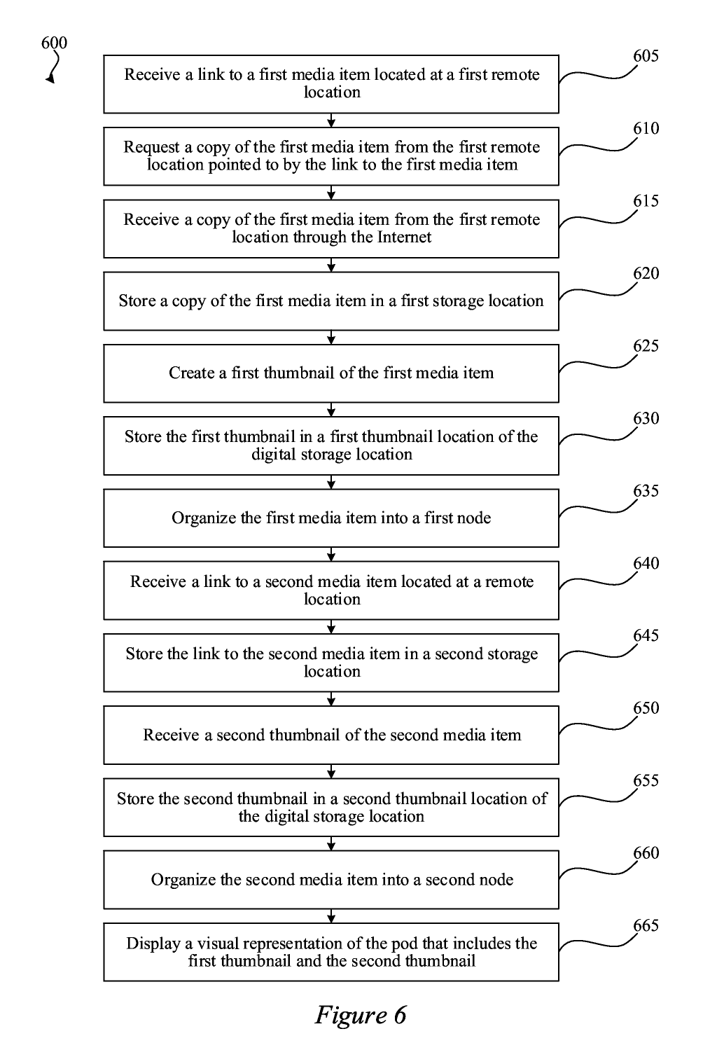

FIG. 6 is a flowchart of an example process 600 for organizing a first media item and a link to a second media item in a folder or a pod according to at least one embodiment described herein. One or more steps of the process 600 may be implemented, in some embodiments, by file system 205, computer 220 and/or mobile device 215. Although illustrated as discrete blocks, various blocks may be divided into additional blocks, reordered, combined into fewer blocks, or eliminated, depending on the desired implementation.

The process 600 may start at block 605 where a link to a first media item located at a first remote location may be received at a server (e.g., the file system 205). The link to the first media item may be received from a client (e.g., a mobile device 215 or a computer 220). The link to the first media item may point to the first media item stored at any remote location such as, for example, a webpage server, another mixed media file system, streaming media 230, YouTube 235, Dropbox, or any other location.

At block 610 a copy of the first media item may be requested from the first media location. The request for the first media item may depend on the type of first remote location. For example, if the first remote location is a webpage server, then the request may include an HTTP GET or an FTP GET command. As another example, the request may include a command as part of the API for the first remote location.

At block 615 a copy of the first media item may be received at the server (e.g., the file system 205) from the first remote location through the Internet. At block 620 the first media item may be stored in a first storage location. For example, once the first media item has been received from the first client the first media item may be stored in data storage 206 or cloud storage location 240 or any other storage location.

At block 625 a first thumbnail of the first media item may be created. For example, the first thumbnail of the first media item may be created from the first media item. For example, the first thumbnail may be created by saving a lower resolution version of the first media item. As another example, the first thumbnail may be created using a third party network resource that returns a thumbnail of a media item in response to receiving the media item. As another example, the first thumbnail may be created from a frame or page of the first media item.

At block 630 the first thumbnail may be stored in a first storage location. For example, once the first thumbnail may be stored in data storage 206 or cloud storage location 240 or any other storage location.

At block 635 the first media item may be organized into a node and/or a pod as described within this disclosure. As another example, the first media item may be organized in a folder with one or more other media items.

At block 640 a link to a second media item located at a second remote location may be received. The link to the second media item may be received from the first client or another client. The link to the second media item may point to the second media item stored at a second remote location such as, for example, at streaming media 230, YouTube 235, or any other location.

At block 645 the link to the second media item may be stored in a second storage location. For example, once the second media item has been received the second media item may be stored in data storage 206 or cloud storage location 240 or any other storage location.

At block 650 a second thumbnail may be received from the second remote location. In some embodiments, the second thumbnail may be requested from the second remote location. In some embodiments, the second thumbnail may be requested through an API associated with the second remote location.

At block 655 the second thumbnail may be stored in a second storage location. For example, once the second thumbnail is received from the second remote location the second thumbnail may be stored in data storage 206 or cloud storage location 240 or any other storage location.

At block 660 the second media item may be organized into a pod that includes the link to the second media item but not the second media item or a copy of the second media item. As another example, the second media item may be organized in a folder with one or more other media items. The first media item and the second media item, for example, may be organized in the same pod or folder without regard to the difference in the storage location of the first media item and the second media item. The first media item and the second media item, as another example, may be organized in the same pod or folder without regard to the difference in that the first media item is stored at the file system 205 and only a link of the second media item is stored at the file system 205.

At block 665 the visual representation of the pod may be displayed on the first client. For example, a display may be created and sent to the first client. As another example, an HTML or other markup language file may be sent to the first client and may be displayed by the first client.

In some embodiments, a request to view the first media item may be received from a first client device. The first media item may be retrieved from the first storage location and a visual representation of the first media item based on the first media item may be created. For example, the visual representation of the first media item may include the first media item. As another example, the visual representation of the first media item may include an HTML or other markup language file. The first media item may then be displayed at the first client device making the request.

A second request to view the second media item may be received from a second client device. In response, the link to the second media item may be sent to the second client device. The second client device may be the same as the first client device.

A second request to view the second media item may be received from a second client device. A visual representation of the second media item may be created by embedding the second media item (or the link to the second media item) as part of a display or file without storing the second media item in the storage location. For example, the second media item may be embedded with an HTML file (or other markup language file). The visual representation of the second media item may then be displayed at the second client device. In some embodiments, the second media item may be streamed from the second file location to the second client device

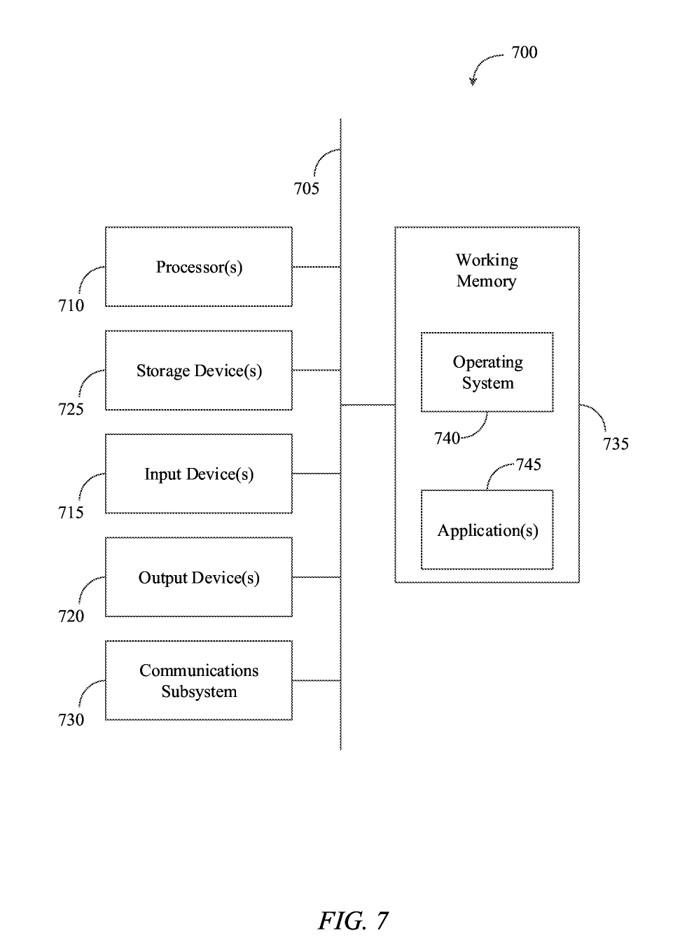

The computational system 700 (or processing unit) illustrated in FIG. 7 can be used to perform any of the embodiments of the invention. For example, the computational system 700 can be used alone or in conjunction with other components. As another example, the computational system 700 can be used to perform any calculation, solve any equation, perform any identification, and/or make any determination described herein. The computational system 700 includes hardware elements that can be electrically coupled via a bus 705 (or may otherwise be in communication, as appropriate). The hardware elements can include one or more processors 710, including, without limitation, one or more general-purpose processors and/or one or more special-purpose processors (such as digital signal processing chips, graphics acceleration chips, and/or the like); one or more input devices 715, which can include, without limitation, a mouse, a keyboard, and/or the like; and one or more output devices 720, which can include, without limitation, a display device, a printer, and/or the like.

The computational system 700 may further include (and/or be in communication with) one or more storage devices 725, which can include, without limitation, local and/or network-accessible storage and/or can include, without limitation, a disk drive, a drive array, an optical storage device, a solid-state storage device, such as random access memory (“RAM”) and/or read-only memory (“ROM”), which can be programmable, flash-updateable, and/or the like. The computational system 700 might also include a communications subsystem 730, which can include, without limitation, a modem, a network card (wireless or wired), an infrared communication device, a wireless communication device, and/or chipset (such as a Bluetooth® device, an 802.6 device, a WiFi device, a WiMAX device, cellular communication facilities, etc.), and/or the like. The communications subsystem 730 may permit data to be exchanged with a network (such as the network described below, to name one example) and/or any other devices described herein. In many embodiments, the computational system 700 will further include a working memory 735, which can include a RAM or ROM device, as described above.

The computational system 700 also can include software elements, shown as being currently located within the working memory 735, including an operating system 740 and/or other code, such as one or more application programs 745, which may include computer programs of the invention, and/or may be designed to implement methods of the invention and/or systems of the invention, as described herein. For example, one or more procedures described with respect to the method(s) discussed above might be implemented as code and/or instructions executable by a computer (and/or a processor within a computer). A set of these instructions and/or codes might be stored on a computer-readable storage medium, such as the storage device(s) 725 described above.

In some cases, the storage medium might be incorporated within the computational system 700 or in communication with the computational system 700. In other embodiments, the storage medium might be separate from the computational system 700 (e.g., a removable medium, such as a compact disc, etc.), and/or provided in an installation package, such that the storage medium can be used to program a general-purpose computer with the instructions/code stored thereon. These instructions might take the form of executable code, which is executable by the computational system 700 and/or might take the form of source and/or installable code, which, upon compilation and/or installation on the computational system 700 (e.g., using any of a variety of generally available compilers, installation programs, compression/decompression utilities, etc.), then takes the form of executable code.

Numerous specific details are set forth herein to provide a thorough understanding of the claimed subject matter. However, those skilled in the art will understand that the claimed subject matter may be practiced without these specific details. In other instances, methods, apparatuses, or systems that would be known by one of ordinary skill have not been described in detail so as not to obscure claimed subject matter.

Some portions are presented in terms of algorithms or symbolic representations of operations on data bits or binary digital signals stored within a computing system memory, such as a computer memory. These algorithmic descriptions or representations are examples of techniques used by those of ordinary skill in the data processing art to convey the substance of their work to others skilled in the art. An algorithm is a self-consistent sequence of operations or similar processing leading to a desired result. In this context, operations or processing involves physical manipulation of physical quantities. Typically, although not necessarily, such quantities may take the form of electrical or magnetic signals capable of being stored, transferred, combined, compared, or otherwise manipulated. It has proven convenient at times, principally for reasons of common usage, to refer to such signals as bits, data, values, elements, symbols, characters, terms, numbers, numerals, or the like. It should be understood, however, that all of these and similar terms are to be associated with appropriate physical quantities and are merely convenient labels. Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical, electronic, or magnetic quantities within memories, registers, or other information storage devices, transmission devices, or display devices of the computing platform.

The system or systems discussed herein are not limited to any particular hardware architecture or configuration. A computing device can include any suitable arrangement of components that provides a result conditioned on one or more inputs. Suitable computing devices include multipurpose microprocessor-based computer systems accessing stored software that programs the computing system from a general-purpose computing apparatus to a specialized computing apparatus implementing one or more embodiments of the present subject matter. Any suitable programming, scripting, or other type of language or combinations of languages may be used to implement the teachings contained herein in software to be used in programming or configuring a computing device.

Embodiments of the methods disclosed herein may be performed in the operation of such computing devices. The order of the blocks presented in the examples above can be varied—for example, blocks can be re-ordered, combined, and/or broken into sub-blocks. Certain blocks or processes can be performed in parallel.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

While the present subject matter has been described in detail with respect to specific embodiments thereof, it will be appreciated that those skilled in the art, upon attaining an understanding of the foregoing, may readily produce alterations to, variations of, and equivalents to such embodiments. Accordingly, it should be understood that the present disclosure has been presented for-purposes of example rather than limitation, and does not preclude inclusion of such modifications, variations, and/or additions to the present subject matter as would be readily apparent to one of ordinary skill in the art.

That which is claimed:

1. A method for creating and displaying media items, the method comprising:
receiving a first media item from a first client;
storing the first media item in a first storage location;
receiving a link to a second media item located at a remote location;
storing the link to the second media item in a second storage location;
organizing the first media item into a mixed media file system including the first media item;
organizing the second media item into the mixed media file system including the link to the second media item;
creating a visual representation of the mixed media file system that includes a representation of the first media item and a representation of the second media item, wherein the representation of the first media item and the representation of the second media item are not distinguishable based on the difference in the first storage location of the first media item and the second storage location of the second media item; and
displaying the visual representation of the file management system on the first client.

2. The method according to claim 1, further comprising:
creating a first thumbnail of the first media item; and
creating a second thumbnail of the second media item from the link to the second media item;
wherein the visual representation of the mixed media file system includes the first thumbnail and the second thumbnail.

3. The method according to claim 1, further comprising:
creating a first thumbnail of the first media item; and
receiving a second thumbnail of the second media item from the remote location;
wherein the visual representation of the mixed media file system includes the first thumbnail and the second thumbnail.

4. A method for creating and displaying media items, the method comprising:
receiving a link to a first media item located at a first remote location;
requesting a copy of the first media item from the first remote location pointed to by the link to the first media item;
receiving a copy of the first media item from the first remote location through the Internet;
storing the copy of the first media item in a first storage location;
organizing the first media item into a mixed media file system including the copy of the first media item;
receiving a link to a second media item located at a second remote location;
organizing the second media item into the mixed media file system including the link to the second media item;
creating a visual representation of the mixed media file system that includes a representation of the first media item and a representation of the second media item; and
displaying the visual representation of the mixed media file system.

5. The method according to claim 4, wherein the representation of the first media item and the representation of the second media item are not distinguishable based on the a difference in the storage location of the first media item and the second media item.

6. The method according to claim 4, further comprising:
creating a first thumbnail of the first media item from the copy of the first media item in a first storage location; and
creating a second thumbnail of the second media item from the link to the second media item;
wherein the visual representation of the mixed media file system includes the first thumbnail and the second thumbnail.

7. The method according to claim 4, further comprising:
downloading a first thumbnail of the first media item from the link to the first media item; and
downloading a second thumbnail of the second media item from the link to the second media item;
wherein the visual representation of the mixed media file system includes the first thumbnail and the second thumbnail.

8. The method according to claim 4, further comprising:
receiving a request from a client to view the first media item;
retrieving the first media item from the first storage location;
creating a visual representation of the first media item based on the first media item; and
displaying the visual representation of the first media item.

9. The method according to claim 4, further comprising:
receiving a request from a client to view the second media item; and
providing the link to the second media item to the client.

10. The method according to claim 4, further comprising:
receiving a request from a client to view the second media item; and
creating a visual representation of the second media item by embedding the second media item without storing the second media item in the storage location; and
displaying the visual representation of the second media item.

11. The method according to claim 10, wherein
organizing the first media item into a mixed media file system includes defining a first sort order of the first media item within the mixed media file system;
organizing the second media item into a mixed media file system includes defining a second sort order of the second media item within the mixed media file system; and
the representation of the first media item and the representation of the second media item in the visual representation of the mixed media file system are organized based on the either or both the first sort order and the second sort order.

12. The method according to claim 4, wherein the copy of the first media item includes a file name, the method further comprising:
receiving a title for the first media item from a client device;
saving the title with the first media item; and
providing the title as part of the representation of the first media item.

13. The method according to claim 4, wherein organizing the first media item into a mixed media file system comprises:
creating a first node associated with the first media item;
assigning a node type as the first media type;
assigning the first storage location as a content location of the first node;
assigning the first node to a first pod;
wherein organizing the second media item into a mixed media file system comprises:
creating a second node associated with the second media item;
assigning a node type as the second media type;
assigning the a second storage location as a content location of the second node; and
assigning the second node to the first pod.

14. A method for creating and displaying media items, the method comprising:
receiving a link to a first media item located at a first remote location;
requesting a copy of the first media item from the first remote location pointed to by the link to the first media item;
receiving a copy of the first media item from the first remote location through the Internet;
storing the copy of the first media item at a first storage location of a digital storage location;
creating a first thumbnail of the first media item;
storing the first thumbnail in a first thumbnail location of the digital storage location;
organizing the first media item into a first node by assigning the first storage location as the source of the media, the first thumbnail location as the source of the thumbnail, and assigning the first node to a pod;
receiving a link to a second media item located at a second remote location;
storing the link to the second media item at a second storage location of the digital storage location;
creating a second thumbnail of the second media item;
storing the second thumbnail in a second thumbnail location of the digital storage location;
organizing the second media item into a second node by assigning the link to the second media item located at a second remote location as the source of the media, the second thumbnail location as the source of the thumbnail, and assigning the second node to the pod; and
displaying a visual representation of the pod that includes the first thumbnail and the second thumbnail.

15. The method according to claim 14, wherein in response to a client interaction with the first thumbnail in the visual representation of the pod, retrieving the first media item from the first storage location of the digital storage location and displaying the first media item; and
wherein in response to a client interaction with the second thumbnail in the visual representation of the pod, retrieving the second media item from the second remote location and displaying the second media item.

16. The method according to claim 14, wherein in response to a client interaction with the first thumbnail in the visual representation of the pod, retrieving the first media item from the first storage location of the digital storage location and displaying the first media item; and
wherein in response to a client interaction with the second thumbnail in the visual representation of the pod, providing the link to a client.

17. The method according to claim 14, wherein the representation of the first media item and the representation of the second media item are not distinguishable based on the difference in the storage location of the first media item and the second media item.

18. The method according to claim 17, further comprising:
receiving a request from a client to view the first media item;
retrieving the first media item from the first storage location of the digital storage location;
creating a visual representation of the first media item based on the first media item; and
displaying the visual representation of the first media item.

19. The method according to claim 17, further comprising:
receiving a request from a client to view the second media item; and
providing the link to the second media item to the client.

20. The method according to claim 17, further comprising:
receiving a request from a client to view the second media item; and
creating a visual representation of the second media item by embedding the second media item without storing the second media item in the digital storage location and
displaying the visual representation of the second media item.
